(19) United States
(12) Patent Application Publication
(10) Pub. No.: US 2010/0115971 A1
(43) Pub. Date: May 13, 2010

(54) CRYOPUMP

(75) Inventor: Ryosuke Tsuyuki, Tokyo (JP)

Correspondence Address: RADER FISHMAN & GRAUER PLLC, LION BUILDING, 1233 20TH STREET N.W., SUITE 501, WASHINGTON, DC, 20036, US

(73) Assignee: Sumitomo Heavy Industries, Ltd., Tokyo (JP)

(21) Appl. No.: 12/452,532

(22) PCT Filed: Jul. 23, 2007
(86) PCT No.: PCT/JP2007/064461

§ 371 Date: Jan. 7, 2010

(51) Int. Cl. B01D 8/00; F25B 19/00

(52) U.S. Cl. 62/55.5; 62/268

(57) ABSTRACT

A cryogenic refrigerator of a cryopump generates cryogenic cooling in an expansion volume by reciprocally moving a displacer in a cylinder. A cryopanel and a cup-shaped shield are received in a vacuum chamber of the cryopump and are cooled by the cryogenic cooling. The shield protects the cryopanel from radiant heat of the vacuum chamber. A louver is provided at an upper opening of the shield. A hole is formed at a bottom or side of the cup-shaped shield defining a storage part. Molecules in the vacuum chamber are solidified at or absorbed by the cryopanel and the shield. During regeneration, temperature of the cryopanel and the shield is increased. Water molecules desorbed and liquefied from the louver, the shield or the cryopanel are accumulated during regeneration at the storage part that has enough volume to store the water molecules.

### TECHNICAL FIELD

The present invention generally relates to cryopumps (cryogenic pumps). More specifically, the present invention relates to a cryopump which can achieve improvement of regeneration efficiency.

### BACKGROUND ART

There is, for example, a need to realize a high vacuum state in semiconductor manufacturing equipment. Cryopumps have been frequently used as vacuum pumps configured to realize the high vacuum state. The cryopump requires a cryogenic cooler in principle for vacuum generation. A GM (Gifford-McMahon) cycle type cryogenic cooler (hereinafter, GM type cryogenic cooler) has been used as the cryogenic cooler for the cryopump. The GM type cryogenic cooler and a cryopanel and a shield provided in a vacuum chamber are thermally connected to each other. The high vacuum state is realized by freezing or absorbing gas (for example, argon gas) in the vacuum chamber with the cryopanel or the like in a cooling process.

Regeneration is required for such a cryopump due to its structure. Here, regeneration is a process where heat is applied to molecules solidified at or absorbed by the cryopanel or the like in the cooling process so that temperature is increased and the molecules are liquefied and volatilized and discharged to outside of a pump apparatus.

At the time of regeneration of the cryopump, temperatures of the cryopanel and the shield are increased by a temperature increasing apparatus such as a heater. Purge gas such as nitrogen gas is introduced into the vacuum chamber. Under this structure, the molecules having been solidified at the cryopanel and the shield are liquefied so as to fall due to their own weight, and thereby liquid accumulates inside the shield. In this state, when it is attempted to volatilize and discharge all of the liquid, the shield is cooled by the liquid remaining inside. Accordingly, it takes a long time to volatilize the residual liquid and therefore regeneration efficiency is reduced.

Because of this, a cryopump described in Patent Document 1 has been suggested. In this cryopump, a hole is formed in a shield and liquid flows into a vacuum chamber via the hole. In the cryopump having the above-mentioned structure, it is possible to use heat in the vacuum chamber having a normal temperature to volatilize the liquid. Hence, in this cryopump compared with a cryopump where the hole is not formed in the shield, it is possible to achieve improvement of the regeneration efficiency.

### [Patent Document 1] Japanese Patent Application Publication No. 5-33766

### DISCLOSURE OF THE INVENTION

### Problems to be Solved by the Invention

However, depending on the semiconductor manufacturing equipment where the cryopump is connected, water may be solidified together with gas such as argon gas at the vacuum generation time in the cryopump. Thus, when a regeneration process is applied to the cryopump where water and molecules other than water are solidified, liquid other than the above-mentioned water is accumulated in the shield and then water is accumulated. Furthermore, the liquid other than water and water flow into the vacuum chamber via the hole formed in the shield.

In general, the boiling point of gas such as argon gas is low (boiling point of argon gas: −185.9° C.) and different from the boiling point of water (99.974° C.). Because of this, even if liquefied argon are volatilized from the vacuum chamber so as to be discharged from the vacuum chamber, water remains inside the vacuum chamber.

It is normal practice that a heating part such as a heater is not provided in the vacuum chamber of the cryopump. Therefore, the temperature of the vacuum chamber rises until it reaches room temperature. However, argon or the like having a low boiling point can be volatilized in a short period of time even at normal temperature so as to be discharged from the vacuum chamber. On the other hand, if water having a boiling point higher than room temperature remains in the vacuum chamber, it takes a long period of time to vaporize the water and discharge the water from the cryopump. Because of this, it takes a long period of time for regeneration so that the regeneration efficiency may be degraded.

### Means for Solving Problems

Accordingly, embodiments of the present invention may provide a novel and useful cryopump solving one or more of the problems discussed above.

More specifically, the embodiments of the present invention may provide a cryopump whereby time for regeneration can be reduced even if water and molecules other than water are solidified at the time of vacuum generation.

One aspect of the present invention may be to provide a cryopump, including a cryogenic refrigerator configured to generate cryogenic cooling in an expansion volume by reciprocally moving a displacer in a cylinder; a vacuum chamber; a cryopanel received in the vacuum chamber and being cooled by the cryogenic cooling generated in the expansion volume; a shield having a cup-shaped configuration, the shield being received in the vacuum chamber, the shield being cooled by the cryogenic cooling generated in the expansion volume, the shield being configured to protect the cryopanel from radiant heat of the vacuum chamber; a louver provided at an upper part opening of the cup-shaped configuration of the shield; and a temperature increasing apparatus configured to increase temperatures of the cryopanel and the shield at a time of regeneration, wherein molecules in the vacuum chamber are solidified at or absorbed by the cryopanel and the shield, and the shield includes a hole part formed in a bottom part or a side part of the cup-shaped configuration, and a water accumulating part having a storage part, the storage part being defined at the bottom part of the cup-shaped configuration by a position of the hole part, the storage part being where water desorbed from the louver, the shield, or the cryopanel and liquefied can be stored.

A dam part may be formed at the hole part; the dam part may project toward an inside of the shield; and the dam part may surround the hole part.

A bottom surface of the shield may be inclined; the hole part may be formed on the inclined bottom surface; and the water accumulating part may be formed in an area lower than the hole part at the inclined surface.

The temperature increasing apparatus may include a reversible motor whereby rotation in a forward direction and rotation in a reverse direction of the motor are performed; and the temperature of the shield may be increased by rotating the reversible motor in the reverse direction so that a cooling cycle is reversed.

Other objects, features, and advantages of the present invention will become more apparent from the following detailed description when read in conjunction with the accompanying drawings.

### EFFECT OF THE INVENTION

According to the embodiment of the present invention, the flow-out hole configured to flow out molecules other than liquefied water to the vacuum chamber is provided in the shield. Therefore, the molecules other than liquefied water use heat of the vacuum chamber having a normal temperature and are volatilized so as to be discharged. Therefore, it is possible to efficiently discharge the molecules other than liquefied water from the cryopump in a short period of time.

In addition, the water in the liquefied state are prevented from flowing out from the flow-out hole by the water accumulating part provided at the shield so as to remain in the water accumulating part (shield). The temperature of the shield can be increased to be equal to or higher than normal temperature by a temperature increasing apparatus. Accordingly, even if the water remains in the water accumulating part formed at the shield, it is possible to volatilize the water in a short period of time so as to be discharged from the cryopump. Accordingly, it is possible to discharge either the water or molecules other than liquefied water from the cryopump so that reduction of regeneration time can be achieved.

### BRIEF DESCRIPTION OF DRAWINGS

FIG. 1 is a structural view of a cryopump of an embodiment of the present invention;

FIG. 2 is another structural view of the cryopump of the embodiment of the present invention and shows gas solidified to a solid state at or absorbed by a shield or a cryopanel;

FIG. 3 is another structural view of the cryopump of the embodiment of the present invention and a first view for explaining a regeneration process;

FIG. 4 is another structural view of the cryopump of the embodiment of the present invention and a second view for explaining the regeneration process;

FIG. 5 is a graph showing a discharge time characteristic with comparison to a related art case;

FIG. 6 is a structural view of a cryopump of a first modified example of the embodiment of the present invention;

FIG. 7 is a structural view of a cryopump of a second modified example of the embodiment of the present invention; and

FIG. 8 is a structural view of a cryopump of a third modified example of the embodiment of the present invention.

### EXPLANATION OF REFERENCE SIGNS

1, 30 cryopump
3 compressor
4 vacuum chamber
5 cryogenic cooler
7 first stage cooling stage
8 second stage cooling stage
9 shield
10 cryopanel
11 activated carbon
12 louver
13 roughing vacuum pump
14 first stage cylinder
14A first stage displacer
15 second stage cylinder
15A second stage displacer
16 reversible motor
17 purge pipe
18 flow-out hole
19 dam part
20, 32 water accumulating part
21 captured molecules
21A water molecules (solid state)
22 liquid
23 water
31 inclination surface

### BEST MODE FOR CARRYING OUT THE INVENTION

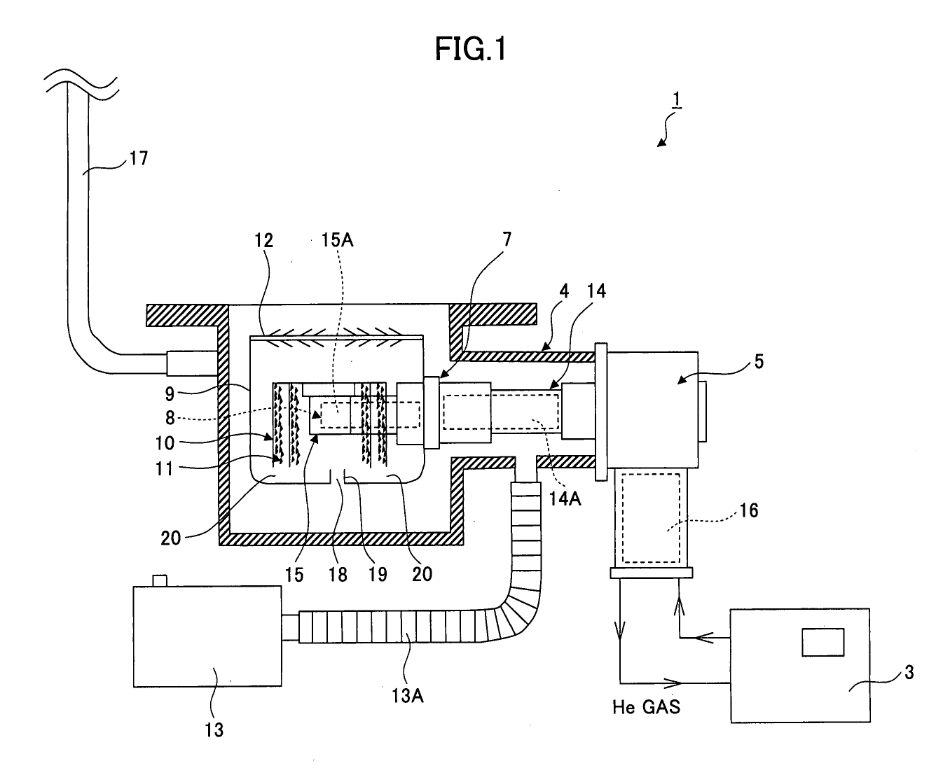

A description is given below of embodiments where a cryopump is applied, with reference to FIG. 1 through FIG. 8 according to embodiments of the present invention.

FIG. 1 shows a cryopump of the embodiment of the present invention. A cryopump 1 is provided in a process chamber not illustrated in FIG. 1 (for example, a process chamber of a semiconductor manufacturing apparatus). The inside of the process chamber is under vacuum. The cryopump 1 includes a compressor 3, a vacuum chamber 4, a cryogenic cooler 5, a shield 9, a cryopanel 10 and others. Temperatures of the shield 9 and the cryopanel 10 at the time of regeneration are increased based on a so-called reverse temperature increase where the cooling cycle of the cryogenic cooler 5 is reversed.

The compressor 3 is configured to increase the pressure of coolant gas such as helium gas so as to supply the coolant gas to the cryogenic cooler 5. In addition, the compressor 3 is configured to receive the coolant gas being adiabatically expanded by the cryogenic cooler 5 and increase the temperature of the coolant gas again. The vacuum chamber 4 is provided in the above-mentioned process chamber. Cylinders 14 and 15, the shield 9, the cryopanel 10, and others are provided inside the vacuum chamber 4.

A roughing vacuum pipe 13A and a purge pipe 17 are connected to the vacuum chamber 4. The roughing vacuum pipe 13A is connected to a roughing vacuum pump 13 (vacuum pump). The roughing vacuum pipe 13A is configured to roughly vacuum gas inside the vacuum vessel 4 when a vacuum process starts. In addition, the purge pipe 17 is connected to, for example, a nitrogen gas supply part. The purge pipe 17 is configured to supply purge gas (nitrogen gas) into the vacuum chamber 4 at the time of regeneration discussed below. A gate valve not illustrated in FIG. 1 is provided between the vacuum chamber 4 and the process chamber. By closing the gate valve, the vacuum chamber 4 can be sealed and isolated relative to the process chamber.

The cryogenic cooler 5 is a GM (Gifford-McMahon) type cryogenic cooler. The cryogenic cooler 5 includes a first stage cylinder 14, a second stage cylinder 15, a reversible motor 16, and others. A first stage displacer 14A is provided inside the first stage cylinder 14 and configured to reciprocally move in left and right directions in FIG. 1. A second stage displacer 15A is provided inside the second stage cylinder 15 and configured to reciprocally move in left and right directions in FIG. 11. The first stage displacer 14A and the second stage displacer 15A are connected to each other and configured to reciprocally move in the cylinders 14 and 15, respectively, as discussed above by using the reversible motor 16 as a driving source.

A first adiabatic expansion volume is formed between the first stage cylinder 14 and the first stage displacer 14A. A second adiabatic expansion volume is formed between the second stage cylinder 15 and the second stage displacer 15A; and

The reversible motor 16 rotates in a forward direction and in a reverse direction. The reversible motor 16 is connected to a controller not illustrated in FIG. 1. Following orders from the controller, the rotation in the forward direction is performed during the vacuum process and the rotation in the reverse direction is performed at the time of regeneration.

A first stage cooling stage 7 is provided at an external circumference of the first stage cylinder 14. In addition, the shield 9 is provided at the first stage cooling stage 7.

The shield 9 is configured to protect the cryopanel 10 from radiant heat of the vacuum chamber 4. The shield 9 is a cup-shaped member where an upper part of the shield 9 is opened. A louver 12 is provided at an upper part opening part of the shield 9. The louver 12 is provided so as to close an upper part opening of the vacuum chamber 4.

A flow-out hole (hole part) 18 is formed in a bottom surface of the shield 9. In this embodiment, the bottom surface of the shield 9 is a horizontal surface. The flow-out hole 18 is formed in the center position of the bottom surface of the shield 9. The flow-out hole 18 has a dam part 19 projecting toward the inside of the shield 9 (upward in FIG. 1).

The dam part 19 is formed so as to surround the flow-out hole 18. The dam part 19 can be simultaneously formed with the flow-out hole 18 by applying, for example, a pressing and stamping process to a bottom surface of the shield 9. The dam part 19 can be formed by connecting a pipe-shaped member to the opening part of the flow-out hole 18 by welding or the like.

Thus, a water accumulating part 20 is formed at the bottom part of the shield 9 by forming the dam part 19 at the bottom surface of the shield 9 so that the flow-out hole 18 is surrounded by the dam part 19. Since the water accumulating part 20 is formed, even if molecules other than liquefied water fall on the bottom part of the shield 9 at an initial stage of a temperature increasing step discussed below, the molecules do not immediately flow out to enter inside the vacuum chamber 4 via the flow out hole 18. The molecules are stored on the bottom part of the shield 9 for a while. When a liquid surface of the molecules other than the liquefied water exceeds the height of the dam part 19, the molecules other than the liquefied water flow out to enter the inside of the vacuum chamber 4 via the flow out hole 18. In addition, after the molecules other than the liquefied water are discharged, water (liquefied water molecules) generated at a last stage of the temperature increasing step drops on the bottom part of the shield 9. However, this water is stored in the water accumulating part 20 and does not flow out to the vacuum chamber 4. Detailed functions of the water accumulating part 20 are discussed below for the convenience of explanation.

A second stage cooling stage 8 is provided at an external circumference of the second stage cylinder 15. In addition, the cryopanel 10 is provided at the second stage cooling stage 8. Active carbon 11 is provided on an internal circumferential surface of the cryopanel 10.

In a case where the vacuum process is performed at the cryopump 1 having the above-discussed structure, first, the roughing vacuum pump 13 is driven so that roughing of gas in the process chamber and the vacuum vessel 4 is implemented and a vacuum (evacuation) process to, for example, approximately 10 Torr, is implemented. After the roughing vacuum process is completed, the roughing vacuum pump 13 is stopped and the reversible motor 16 is rotated in a forward direction.

As a result of this, the cryogenic cooler 5 is in a cooling mode and coolant gases supplied from the compressor 3 to the first expansion volume and the second expansion volume are adiabatically expanded based on movement of the respective displacers 14A and 15A, so that cryogenic cooling is generated. Because of this, the first stage cooling stage 7 is cooled at, for example, 30 K through 100 K and thereby the shield 9 and the louver 12 are cooled at, for example, 30 K through 100 K. In addition, the second stage cooling stage 8 is cooled at, for example, 4 K through 20 K and thereby the cryopanel 10 is cooled at, for example, 4 K through 20 K.

Gas in the process chamber enters from an upper part opening into the vacuum chamber 4. Water are solidified at the shield 9 (especially, the louver 12). Argon or nitrogen which is other than water is solidified at the cryopanel 10. In addition, hydrogen, neon, helium and others are absorbed by, mainly, the active carbon 11. Thus, the process chamber is evacuated so that a high vacuum state can be realized.

In the meantime, gas molecules other than water discharged from the inside of the process chamber, as discussed above, are solidified at or absorbed by the shield 9, the cryopanel 10, the active carbon 11, and others. In addition, the water are solidified at the shield 9 and the cryopanel 10. In the following explanation, the gas molecules other than the water solidified at or absorbed by the shield 9 and the cryopanel 10 and the solidified water are called, in sum, captured molecules 21.

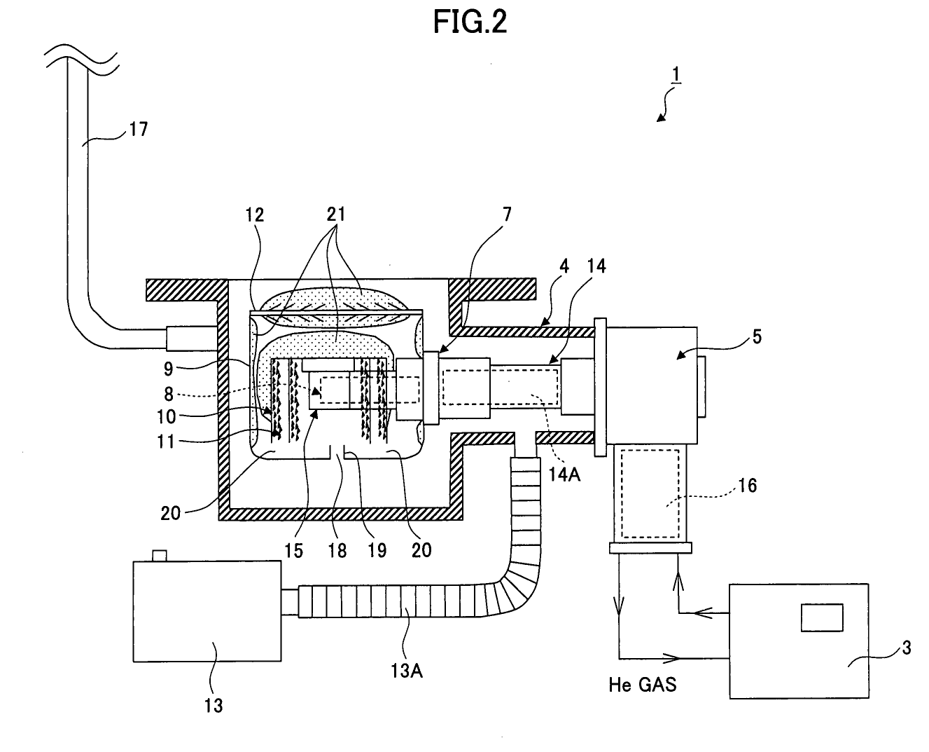

FIG. 2 shows where the captured molecules 21 are solidified at or absorbed by the shield 9 and the cryopanel 10. As the amount of the captured molecules 21 solidified at or absorbed by the shield 9 and the cryopanel 10 is increased, discharge abilities of the cryopump 1 are degraded. Because of this, as discussed above, a regeneration process for discharging the captured molecules 21 solidified at or absorbed by the cryopump 1 is required.

Next, the regeneration process of the cryopump 1 is discussed.

Once the regeneration process starts, first, the gate valve is closed so that the vacuum chamber 4 is sealed and isolated relative to the process chamber. Next, the purge gas is introduced from the purge pipe 17 into the vacuum chamber 4, a drain valve not illustrated is turned on, and the reversible motor 16 is rotated in a reverse direction.

The purge gas is at room temperature. Accordingly, the temperature of the captured molecules 21 is increased by heat of the purge gas so that the captured molecules 21 are liquefied. By reverse rotation of the reversible motor 16, a cooling cycle of the cryogenic cooler 5 is reversed. The coolant gas is adiabatically compressed in the first expansion volume and the second expansion volume so that adiabatic compression heat is generated. (In the following explanation, this temperature increase is called reverse temperature increase). This adiabatic compression heat raises the temperatures of the shield 9 and the cryopanel 10 via the cylinders 14 and 15 and the cooling stages 7 and 8, so that the temperature of the captured molecules 21 is further increased and the captured molecules 21 are liquefied.

Because of temperature increases of the purge gas, the shield 9, and the cryopanel 10, among the captured molecules 21, molecules having a boiling point lower than that of water (argon, nitrogen, or the like) are first liquefied so that that liquid 22 are generated. In the following explanation, the liquid 22 are molecules of argon, nitrogen, or the like other than water.

The liquid 22 fall down on the bottom part of the shield 9 having the cap-shaped configuration by their own weight. As discussed above, since the dam part 19 is provided at the shield 9 so that the water accumulates in the water accumulating part 20, the liquid 22 which fall do not immediately flow out to enter inside the vacuum chamber 4 via the flow out hole 18, but are stored in the water accumulating part 20 for a while.

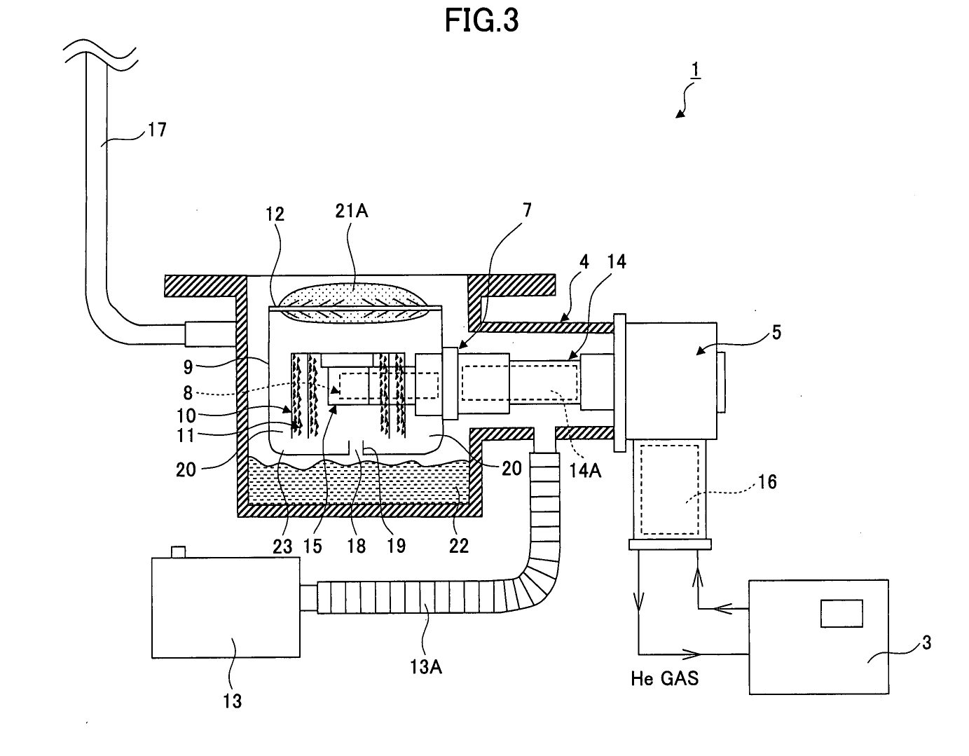

As the regeneration proceeds so that the amount of the liquid 22 is increased, the liquid 22 overflow from the water accumulating part 20 so as to flow into the vacuum chamber 4 via the flow out hole 18. FIG. 3 shows where substantially all the liquid 22 flow out to the vacuum chamber 4. In this state, the water having a high boiling point remains as it is solidified at the louver 12 or the like (the water in this state are shown by a numerical reference 21A in FIG. 3). As discussed above, the temperature of the shield 9 is increased by the cryogenic cooler 5 due to the reverse temperature increase, and the amount of the liquid 22 accumulated in the water accumulating part 20 is small. In FIG. 3, a state where the liquid 22 stored in the shield 9 are already liquefied is shown.

The liquid 22 flowing into the vacuum chamber 4 are molecules other than water, such as argon or nitrogen. Therefore, the liquid 22 are easily liquefied by heat of the vacuum chamber 4 held at room temperature. Therefore by forming the flow out hole 18 in the shield 9 so that the liquid 22 can flow out from the shield 9 to the vacuum chamber 4, it is possible to discharge the liquid 22 from the cryopump 1 in a short period of time. Hence, it is possible to improve the regeneration efficiency.

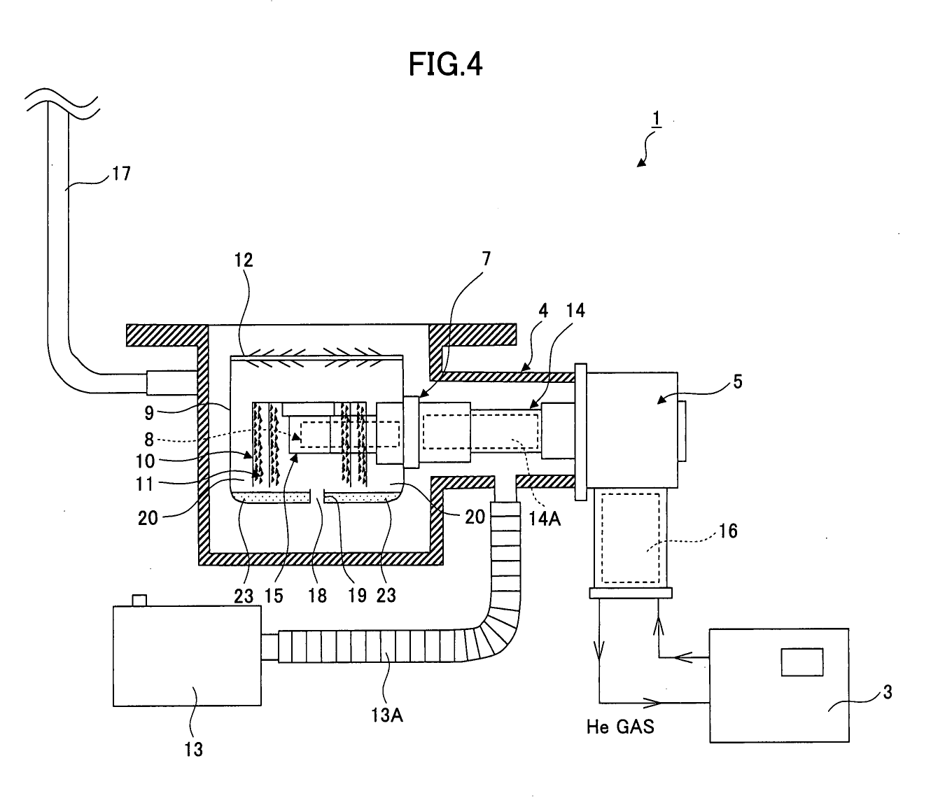

After discharge of the liquid 22 from the cryopump 1 is completed, introduction of the purge gas and the reverse temperature increase of the cryogenic cooler 5 further continue so that the solidified water molecules (indicated by the numerical reference 21A in FIG. 3) are liquefied so that the generated water 23 fall on the bottom part of the shield 9 (see FIG. 4).

The amount of the water 23 generated at a single time of the regeneration process, compared to the generated amount of the liquid 22, is small. In addition, it is possible to experimentally know the amount of the water 23 generated at the single time of the regeneration process. In this embodiment, the volume of the water accumulating part 20 is set based on the amount of the water 23 generated at the single time of the regeneration. In other words, the volume of the water accumulating part 20 is set so as to be substantially equal to the volume of the amount of the water 23 generated at the single time of the regeneration.

Here, the volume of the water accumulating part 20 is determined by the configuration of the bottom surface of the shield 9 and the position and height of the dam part 19. For example, as shown in FIG. 1 through FIG. 4, in a case where the dam part 19 is provided in the center of the bottom having a plane surface of the shield 9 having a cup shaped configuration, it is preferable that the height of the dam part 19 be approximately 3 mm through approximately 12 mm.

The shield 9 is provided so as to protect the cryopanel 10 from the radiant heat of the vacuum chamber 4. Because of this, it is preferable that the aperture of the flow out hole 18 have a certain value even if an aperture of the vacuum chamber 4 is large.

In the cryopump, depending on the atmosphere where the cryopump is used, it is possible to roughly estimate the amount of the water to be stored inside the cryopump. The volume of the water accumulating part 20 may be set so as to correspond to the amount of the water which can be stored in the cryopump 1. Because of this, it is preferable that the height of the dam part 19 be approximately 3 mm through approximately 12 mm.

By setting the height of the dam part 19 and the volume of the water accumulating part 20 as discussed above, it is possible to prevent the water 23 stored in the water accumulating part 20 from flowing out to the vacuum chamber 4 via the flow out hole 18.

As discussed above, although the water 23 stored in the water accumulating part 20 have boiling points higher than those of the liquid 22, the temperature of the shield 9 is increased higher than the room temperature by the reverse temperature increase (the temperature of the shield 9 is increased higher than the temperature of the vacuum chamber 4). Accordingly, the water 23 having boiling points higher than those of the liquid 22 can be liquefied at the water accumulating part 20 of the shield 9 in a short period of time so as to be discharged from the cryopump 1.

Therefore, according to the cryopump 1 of this embodiment, the liquid 22 flowing into the vacuum chamber 4 and the water 23 remaining in the water accumulating part 20 can be liquefied in a short period of time so as to be discharged. Accordingly, it is possible to reduce the regeneration time of the cryopump 1.

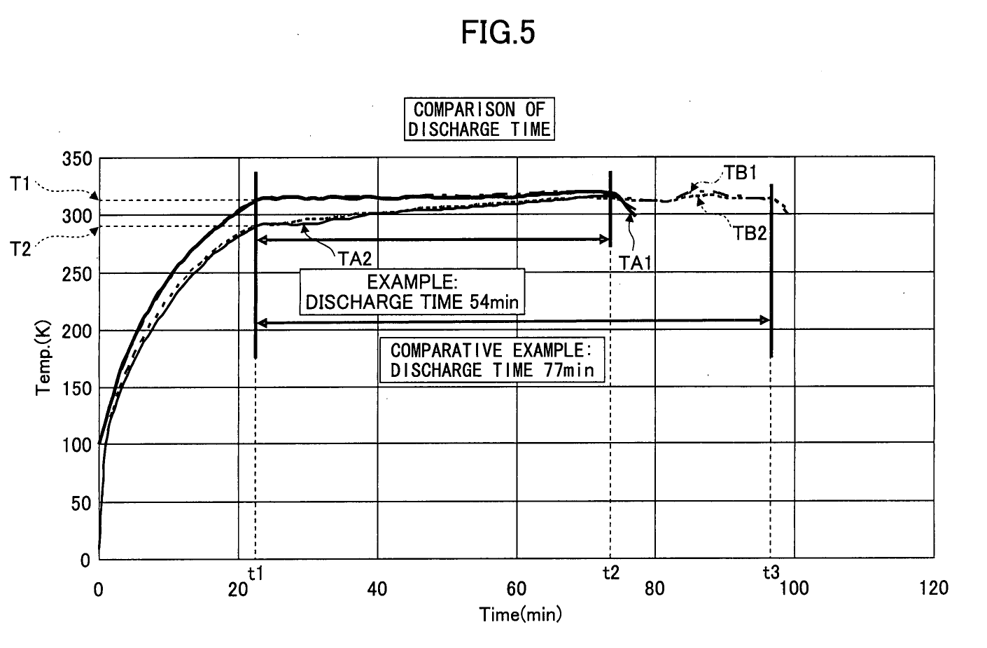

FIG. 5 is a graph showing a discharge time of the water 23 in the cryopump 1 of this embodiment compared with a discharge time required for a cryopump of a related art case. In FIG. 5, the horizontal axis shows time and the vertical axis shows temperature. In the graph shown in FIG. 5, an arrow TA1 indicates a temperature change of the first stage cooling stage 7 of the cryopump 1 of this embodiment. An arrow TA2 indicates a temperature change of the second stage cooling stage 8 of the cryopump 1 of this embodiment.

Temperature characteristics of a cryopump where the dam part 19 (the water accumulating part 20) is not provided are shown as a comparative example in FIG. 5. The cryopump of this comparative example has a structure substantially the same as that of the cryopump 1 except that the damp part 19 (the water accumulating part 20) is not provided in the cryopump of the comparative example. In the graph shown in FIG. 5, an arrow TB1 indicates a temperature change of the first stage cooling stage of the cryopump of the comparative example. An arrow TA2 indicates a temperature change of the second stage cooling stage of the cryopump of the comparative example.

A reverse temperature increase process was performed in the cryopump 1 in a state where water having 20 grams weight is provided in the water accumulating part 20. A reverse temperature increase process was performed in the cryopump of the comparative example where water having 20 grams weight was provided in the vacuum chamber. The temperatures TA1, TA2, TB1, and TB2 were measured. The results of experiment are shown as temperature characteristics in FIG. 5.

Here, the discharge time means a time period from a time t1 when a temperature of the first stage cooling stage reaches a target temperature T1 and a temperature of the second stage cooling stage reaches a target temperature T2 to a time when an internal pressure of the vacuum chamber becomes equal to or lower than a designated pressure by discharging all water (namely, a time when cooling down starts: t2 in this embodiment, t3 in the comparative example).

In the experiment, while it took 54 minutes to discharge water in the cryopump 1 of this embodiment, it took 77 minutes in the cryopump of the comparative example. Through the experiment, it was proved that the regeneration time was drastically reduced in the cryopump 1 of this embodiment compared with the cryopump of the related art.

At the actual regeneration time, not only the water 23 but also the liquid 22 are discharged. Discharge of the liquid 22 having low boiling points is completed earlier than discharge of the water 23 having boiling points higher than the boiling points of the liquid 22. Accordingly, the regeneration time depends on the discharge time of the water 23. Because of this, it can be said that the result of this experiment reflects the actual regeneration process where the liquid 22 are discharged with the water 23.

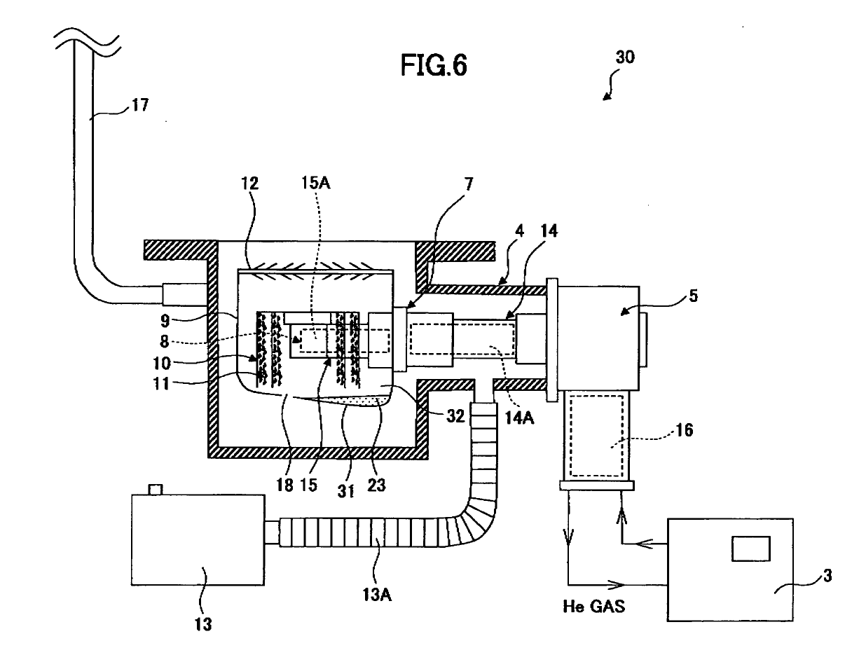

FIG. 6 shows a cryopump 30 of a modified example of the cryopump 1 shown in FIG. 1 through FIG. 4. In the cryopump 1 shown in FIG. 1 through FIG. 4, the dam part 19 is provided in order to prevent the water 23 from flowing out to the vacuum chamber 4 via the flow out hole 18. In this structure, the water accumulating part 20 is formed at the bottom part of the shield 9.

On the other hand, in the cryopump 30 of this modified example, the bottom part of the shield 9 is formed as an inclined surface 31. The flow out hole 18 is formed in an upper position in an inclination direction of the inclined surface 31. Under this structure, as shown in FIG. 6, the water accumulating part 32 where the water 23 can remain is formed at the bottom part of the shield 9. Hence, it is possible to realize a cryopump which can achieve the same action and effect as those of the cryopump 1 shown in FIG. 1 through FIG. 4.

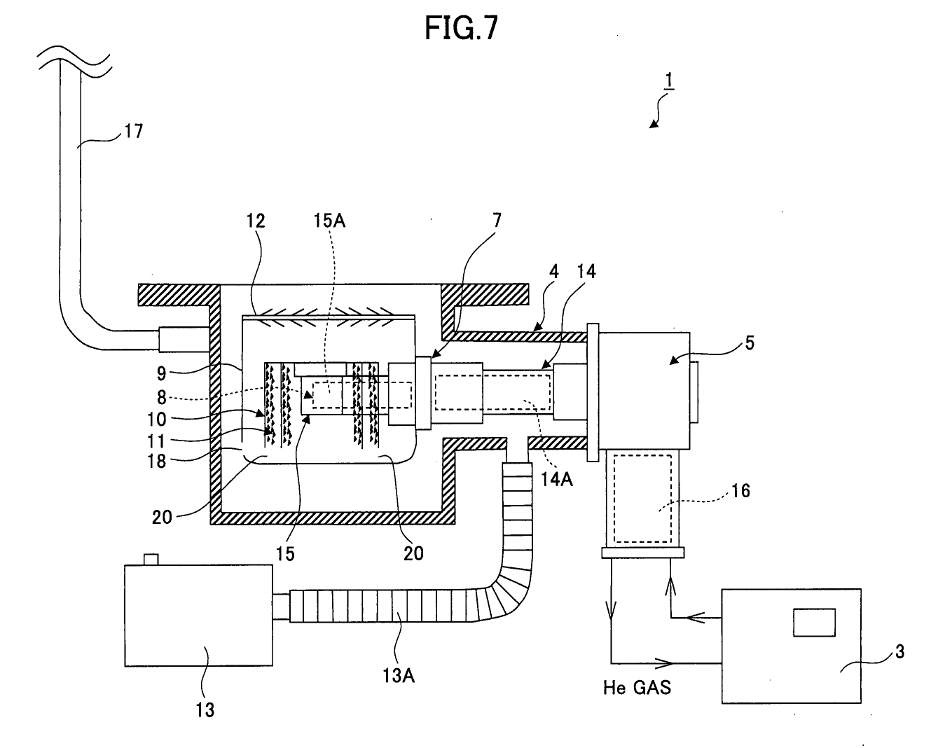

In addition, as shown in FIG. 7, the flow out hole 18 may be formed at a certain height at the side surface of the shield 9 where the volume of the water accumulating part 20 can set to be a designated volume. In this case, the dam part is not always necessary.

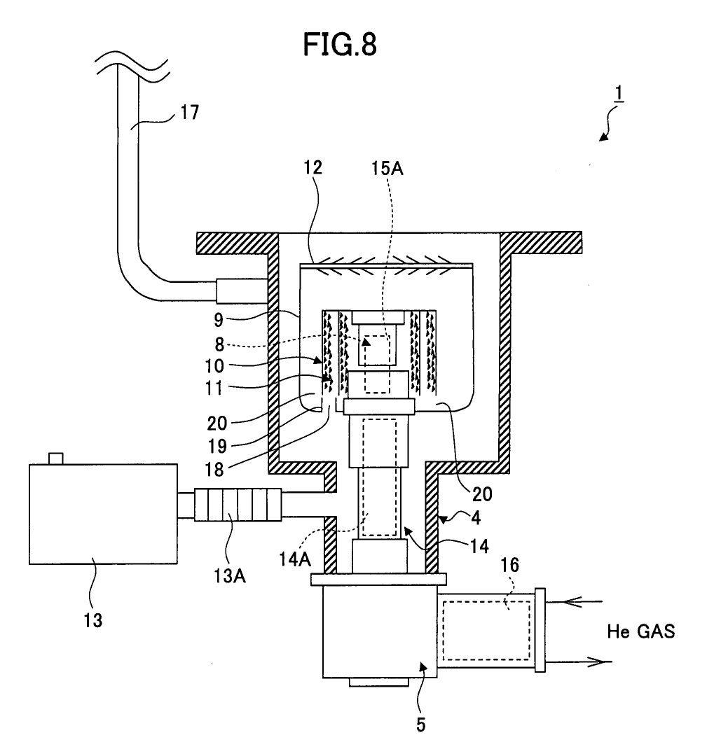

In addition, while an example of a horizontal type cryopump where the cryogenic cooler 5 is inserted from a side of the vacuum chamber 4 is explained in the above description, the flow out hole 18 and the dam part 19 may be formed in a vertical type cryopump shown in FIG. 8 where the cryogenic cooler 5 is inserted from a lower side of the vacuum chamber 4. In the vertical type cryopump, since the cryogenic cooler 5 is inserted upward in a vertical direction from the center of the bottom part of the shield 9 and the vacuum chamber 4, the flow out hole 18 and the dam part 19 may be formed in a position offset from the center of the bottom part of the shield 9. In a case where the bottom surface of the shield 9 deepens from the outside in the diameter direction to the center, the height of the dam part 19 may be set so that a desirable volume of the water accumulating part 20 is secured depending on the configuration of the bottom surface.

Furthermore, in the above-discussed example, the reversible motor 16 is provided as the temperature increasing apparatus. However, in addition to or instead of the reversible motor 16, a heater configured to increase the temperature may be provided.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority or inferiority of the invention. Although the embodiments of the present invention have been described in detail, it should be understood that the various changes, substitutions, and alterations could be made hereto without departing from the spirit and scope of the invention.

1. A cryopump, comprising:
a cryogenic refrigerator configured to generate cryogenic cooling in an expansion volume by reciprocally moving a displacer in a cylinder;
a vacuum chamber;
a cryopanel received in the vacuum chamber and being cooled by the cryogenic cooling generated in the expansion volume;
a shield having a cup-shaped configuration, the shield being received in the vacuum chamber, the shield being cooled by the cryogenic cooling generated in the expansion volume, the shield being configured to protect the cryopanel from radiant heat of the vacuum chamber;
a louver provided at an upper part opening of the cup-shaped configuration of the shield; and
a temperature increasing apparatus configured to increase temperatures of the cryopanel and the shield at a time of regeneration,
wherein molecules in the vacuum chamber are solidified at or absorbed by the cryopanel and the shield, and
the shield includes
a hole part formed in a bottom part or a side part of the cup-shaped configuration, and
a water accumulating part having a storage part, the storage part being defined at the bottom part of the cup-shaped configuration by a position of the hole part, the storage part being where water desorbed from the louver, the shield, or the cryopanel and liquefied can be stored.

2. The cryopump as claimed in claim 1,
wherein a dam part is formed at the hole part;
the dam part projects toward an inside of the shield; and
the dam part surrounds the hole part.

3. The cryopump as claimed in claim 1,
wherein a bottom surface of the shield is inclined;
the hole part is formed on the inclined bottom surface; and
the water accumulating part is formed in an area lower than the hole part at the inclined surface.

4. The cryopump as claimed in claim 1,
wherein the temperature increasing apparatus includes a reversible motor whereby rotation in a forward direction and rotation in a reverse direction of the motor are performed; and
the temperature of the shield is increased by rotating the reversible motor in the reverse direction so that a cooling cycle is reversed.
